(19) United States
(12) Patent Application Publication
(10) Pub. No.: US 2018/0171997 A1
(43) Pub. Date: Jun. 21, 2018

(54) Pump Assisted Chemical Feeder

(71) Applicant: Roger A. Benham, San Diego, CA (US)

(72) Inventor: Roger A. Benham, San Diego, CA (US)

(21) Appl. No.: 15/793,813

(22) Filed: Oct. 25, 2017

Related U.S. Application Data
(60) Provisional application No. 62/496,812, filed on Oct. 31, 2016.

(51) Int. Cl. F04B 49/035; F04B 49/00; C02F 1/00; F04B 49/06; F04B 49/08

(52) U.S. Cl. CPC F04B 49/035; F04B 49/007; C02F 1/006; C02F 9/00; F04B 49/08; C02F 2209/40; C02F 2301/043; F04B 49/06

(57) ABSTRACT

A pump assisted chemical feeder for the treatment of pressurized water systems. There are various methods to dispense chemicals into pressurized water systems, including typical configurations of venturis, slug feeders, and electronic metering pumps. The described invention includes the use of adjustable bypass loops, pumps, and pressure differentials, to provide a reliable and adjustable means of introducing chemicals into a pressurized water system.

### CROSS-REFERENCE TO RELATED APPLICATIONS

The present application is a nonprovisional application of the provisional patent application, titled “Pump Assisted Chemical Feeder”, Application No. 62/496,812, filed Oct. 31, 2016.

### BACKGROUND OF THE INVENTION

The present disclosure is a filed as a provisional patent application.

### 1. Field of the Invention

The present invention relates to a chemical injection apparatus and in particular to a water treatment system for pressurized piping systems in buildings, where the chemical injection rate of said water treatment system is adjusted to be proportional to the flow rate in a supply pipe by means of an adjustable pump flow loop, where said adjustable pump flow loop consists of a pump with multiple loops configured with means of changing flow resistance, therefore adjusting the dispensing rate.

### 2. Discussion of Related Art

Many commercial and residential water supplies suffer from objectionable conditions. Often, treatment measures are implemented with the addition of chemical treatments to the water supply, including for example phosphate or silicate compounds. In order to provido effective treatment and to prevent other problems from occurring, it may be necessary to caretully meter the amount of chemical treatment agent to a given quantity of supplied water.

There are various methods presently available for the injection of chemicals into pressurized piping systems. These various designs all have their benefits and shortcomings. The present invention is designed to provide additional options for injecting water treatment products into a pressurized water pipe, improve reliability, and provide safer treatment compared to other presently available alternatives, and is particularly important for the improvement in quality and cost benefits to the consumer.

### BRIEF SUMMARY OF THE DISCLOSURE

The present invention is directed to an improved chemical dispensing apparatus, which may at least partially overcome the disadvantages of existing systems or provide the consumer with a useful or commercial choice. In a broad form, the invention resides in a fully pressurized chemical injection system that, while under pressure, is impervious to contaminants from the surrounding ambient environment, and has the capability to provide chemical injection into a remote pipeline that is proportional to the flow of liquid in said pipeline. The proportional chemical injection is achieved by using a pump that is integrated into at least two flow loops, each said loop having a means for adjusting the flow resistance within said loop. In the preferred embodiment, said pump has a means of flow rate control using electronic speed control and pumping rate adjustment with a preferred feedback from an outside source such as a flow data measuring and sending unit.

### BRIEF DESCRIPTION OF THE DRAWINGS

FIG. 1 chows the typical layout of an installed water treatment system with a preferred embodiment of the Invention.

FIG. 2 shows a more detailed layout of the multiple flow loops used in the invention.

### DETAILED DESCRIPTION

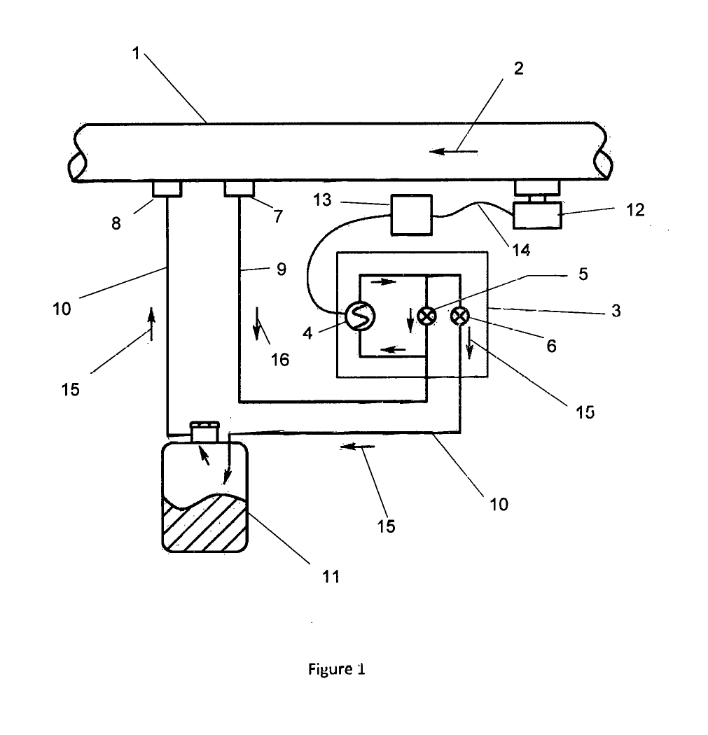

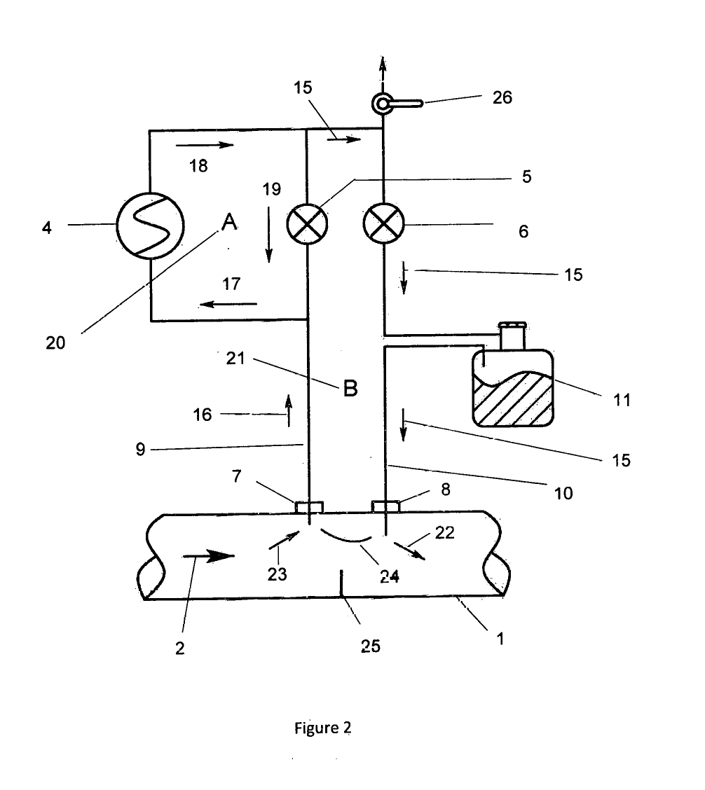

With reference to FIGS. 1 and 2, the chemical injection system and its preferred features and functions are illustrated.

FIG. 1 shows the preferred layout of an installed water treatment system with a preferred embodiment of the invention, along with other ancillary components.. The first component in the piping scheme layout is the pipeline (1) itself with a main water flow (2) that is to be treated with a chemical injection system. The preferred embodiment of the invention is shown enclosed in an enclosure assembly (3), and contains a pump (4) and flow loops. In addition to the pump (4) are valves (5) (6) that are installed on each of the two flow loops. The two flow loops located within the enclosure assembly (3), labelled A and B in FIG. 2, are described in mnre detail in FIG. 2.

Connected to the pipeline (1) are two piping taps, including a supply tap (7) and a return tap (8). Both the supply tap (7) and the return tap (8) are fluidly connected to the enclosure assembly (3) by a supply pipe (9) and a return pipe (10). A bypass chemical dispenser (11) is located within the return pipe (10) between the enclosure assembly (3) and the return tap (8).

Ancillary components shown in the preferred embodiment shown in FIG. 1 include a flow sensor (12) and a flow controller (13) and the associated wiring (14) between the mentioned components and the pump (4).

The preferred embodiment as configured in FIG. 1 results in a flow circuit pattern with controllable flow rates in various sections, including the flow streams (15), (16), (17), (18), and (19), which are shown in mule detail in FIG. 2. FIG. 2 shows a preferred embodiment of the invention, with additional description of the components within the enclosure assembly (3) shown in FIG. 1; along with more detail of the flow characteristics.

FIG. 2 shows two flow circuit loops labelled Loop A (20) and Loop B (21). Examination of Loop A (20) shows that the water flow rate within Loop A (20), comprising of flow rates in each of the legs labelled (17), (18), and (19), can be altered by changing the pumping rate of the pump (4) or by changing the restriction of flow at Valve A (5) or Valve B (6).

Examination of Loop B (21) shows that the water flow rate within Loop B (21), comprising of flow rates in each leg labelled 15, 16, and 19, can be altered by changing the pumping rate of the pump (4), or by changing the restriction of the flow rate at Valve A (5) or Valve B (6).

Examination of the influence of the main water flow (2) at return tap (8) area shows that the proper adjustment of the pump (4) and restrictions at Valve A (5) and Valve B (6), assuming the main water flow if flowing at a reasonable rate, will result in a dispensing of a saturated chemical flow (22) from the chemical dispenser (11), which will flow downstream away from the return tap (8) area. When a saturated chemical flow (22) exits from the return pipe (10) and flows downstream of the return tap (8), to maintain a mass balance within Loop A and Loop B, there must be en equal volume of make-up water flow (23) into the supply pipe (9).

The rate of saturated chemical flow (22) into the pipe can be configured to be proportional to the main water flow (2) in the pipeline (1) using electronic flow meter and pump speed control. In the case where there is no main water flow (2), the pump (4) would be turned off if electronical controlled with flowmeter, or, the saturated chemical flow (22) would flow in the direction of a quasi-saturated chemical flow (24) back to the supply tap (7) area and into the supply pipe (9).

Further adjustments to this phenomenon can be made the use of a flow restrictor (25) installed in the pipeline (1) between the supply tap (7) and the return tap (8). In other embodiments of this invention, instead of a flow restrictor (25), any other means of creating a pressure differential between the supply tap (7) and the return tap (8) can be used, including venturis, pitot tubes, ram tubes, or valves. In the preferred embodiment of this invention, an air purge valve (26) would be located at the highest point to vent air from the piping system.

In compliance with the statute, the invention has been described in language more or less specific to structural or methodical features. It is to be understood that the Invention is not limited to specific features shown or described since the means herein described comprises preferred forms of putting the invention into effect. The invention is, therefore, claimed in any of its forms or modifications within the proper scope of the description and claims appropriately interpreted by those skilled in the art.

1. A chemical injection system comprising: a pressurized chemical dispensing tank; a continuous conduit forming a first flow circuit between said dispensing tank and a remote water pipe; a second continuous conduit forming a second flow circuit appurtenant to said first flow circuit; wherein a pump is installed within said second flow circuit.

2. A chemical injection system according to claim 1 wherein said pump is a centrifugal pump.

3. A chemical injection system according to claim 1 wherein said pump is a positive displacement pump.

4. A chemical injection system according to claim 3 wherein a pressure reducing valve is installed before said positive displacement pump.

5. A chemical injection system according to claim 1 wherein an adjustable restriction valve is installed within said second flow circuit to change the flow rate within said first circuit.

6. A chemical injection system according to claim 5 wherein said adjustable restriction valve installed within said second flow circuit is electronically controlled to change the flow rate within said first circuit.

7. A chemical injection system according to claim 1 wherein a flowmeter is used to electronically regulate the pumping rate of said pump.

8. A chemical injection system comprising: a pressurized chemical dispensing tank; a continuous conduit forming a first flow circuit between said dispensing tank and a remote water pipe; a flow restriction in said remote water pipe between inlet and outlet taps at said remote water pipe that is part of said first flow circuit; a second continuous conduit forming a second flow circuit appurtenant to said first flow circuit; wherein a pump is installed within said second flow circuit.

9. A chemical injection system according to claim 8 wherein said flow restriction within said remote water pipe is an adjustable restriction valve.

10. A chemical injection system according to claim 8 wherein said flow restriction within said remote water pipe is a venturi.

11. A chemical injection system according to claim 8 wherein said flow restriction within said remote water pipe is a pitot tube.

12. A chemical injection system according to claim 11 wherein said pitot tube is configured to produce a ram pressure.

13. A chemical injection system according to claim 8 wherein said pump is a centrifugal pump.

14. A chemical injection system according to claim 8 wherein said pump is a positive displacement pump.

15. A chemical injection system according to claim 14 wherein a pressure reducing valve is installed before said positive displacement pump.

16. A chemical injection system according to claim 8 wherein an adjustable restriction valve is installed within said second flow circuit to change the flow rate within said first circuit.

17. A chemical injection system according to claim 16 wherein said adjustable restriction valve installed within said second flow circuit is electronically controlled to change the flow rate within said first circuit.

18. A chemical injection system according to claim 8 wherein a flowmeter is used to electronically regulate the pumping rate of said pump.
